(19) United States
(12) Patent Application Publication
(10) Pub. No.: US 2021/0055951 A1
(43) Pub. Date: Feb. 25, 2021

(54) INFORMATION PROCESSING DEVICE AND RECORDING MEDIUM ENCODED WITH PROGRAM

(71) Applicant: FANUC CORPORATION, Yamanashi (JP)

(72) Inventor: Hiroki Hokazono, Yamanashi (JP)

(73) Assignee: FANUC CORPORATION, Yamanashi (JP)

(21) Appl. No.: 16/986,432

(22) Filed: Aug. 6, 2020

(30) Foreign Application Priority Data
Aug. 20, 2019 (JP) 2019-150555

(51) Int. Cl. G06F 9/455; G06F 9/50; G06F 11/08

(52) U.S. Cl. CPC G06F 9/45558; G06F 9/5027; G06F 2009/45591; G06F 2009/4557; G06F 11/08

(57) ABSTRACT

To provide an information processing device and recording medium encoded with a program capable easily removing redundancy by detecting the redundancy of identification information. An information processing device for generating an application using a plurality of containers in which a software module is virtualized includes: a container file generation unit which generates a container file from the software module; an identification information determination unit which determines identification information that is new, assigned to a container image and container to be generated from the container file, as new identification information; an identification information comparison unit which compares the new identification information with existing identification information that is identification information of another container image and container which have been generated; and redundancy removal unit which removes redundancy of the existing identification information and the new identification information based on comparison results.

This application is based on and claims the benefit of priority from Japanese Patent Application No. 2019-150555, filed on 20 Aug. 2019, the content of which is incorporated herein by reference.

### BACKGROUND OF THE INVENTION

### Field of the Invention

The present invention relates to an information processing device and a recording medium encoded with a program.

### Related Art

For the practical use of systems, the applying of one system to every physical server has been conventionally carried out. With such practical use, the computational resources of a CPU have surplus, and the cases arise where it is not possible to effectively apply the resources of a physical server.

Nowadays, virtualization technology which effectively applies resources by launching a plurality of virtual servers in one physical server has been known. With virtualization technology, for example, the resources of one physical server are divided, and a system is executed on each of the divided resources. As an example of virtualization technology, container virtual technology has been proposed which isolates the execution environment from other processes, and causes an application to operate in an isolated process. As such container virtualization technology, for example, a system which executes a plurality of containers to perform load distribution has been proposed (refer to Patent Document 1).

Patent Document 1: PCT International Publication No. WO2018/003031

### SUMMARY OF THE INVENTION

In Patent Document 1, the number of operations of a plurality of containers, which are respectively identical processing containers, is increased or decreased. More specifically, in Patent Document 1, whether to stop a container is determined according to the usage status (service use time) of other services. For this reason, in Patent Document 1, identification information for identifying each of the plurality of containers may be the same information.

On the other hand, in the case of executing an application configured by a plurality of containers having different roles, each of the plurality of containers may communicate with each other. In the case of making communication between each of the plurality of containers, each of the plurality of containers must have unique identification information to enable identifying the container which is the communication destination from other containers. Therefore, it would be ideal if possible to detect redundancy of identification information and easily remove redundancy.

A first aspect of the present disclosure relates to an information processing device for generating an application using a plurality of containers in which a software module is virtualized, the information processing device including: a container file generation unit which generates a container file from the software module; an identification information determination unit which determines identification information that is new, assigned to a container image and container to be generated from the container file, as new identification information; an identification information comparison unit which compares the new identification information with existing identification information that is identification information of another container image and container which have been generated; and redundancy removal unit which removes redundancy of the existing identification information and the new identification information based on comparison results.

In addition, a second aspect of the present disclosure relates to a recording medium encoded with a program for causing a computer to operate as an information processing device which generates an application expressed by a container in which a software module is virtualized, the program causing the computer to function as: a container file generation unit which generates a container file from the software module; an identification information determination unit which determines identification information that is new relative to a container image and a container obtained from the container file generated, as new identification information; an identification information comparison unit which compares the new identification information with existing identification information that is identification information of another container image and container which have been generated; and a redundancy removal unit which removes redundancy of the existing identification information and the new identification information based on comparison results.

According to the present disclosure, it is possible to provide an information processing device and recording medium encoded with a program which can detect redundancy of identification information and easily remove redundancy.

### BRIEF DESCRIPTION OF THE DRAWINGS

FIG. 1 is a block diagram showing an information processing device according to an embodiment of the present disclosure;

FIG. 2 is a conceptual drawing showing the configuration of software stored in a software storage unit of the information processing device of the first embodiment;

FIG. 3 is a schematic diagram showing the flow upon generating containers from a software module by a container generation unit of the information processing device of the first embodiment;

FIG. 4 is a flowchart showing the flow of operation of the information processing device of the first embodiment; and

FIG. 5 is a block diagram showing an information processing device of a second embodiment of the present disclosure.

### DETAILED DESCRIPTION OF THE INVENTION

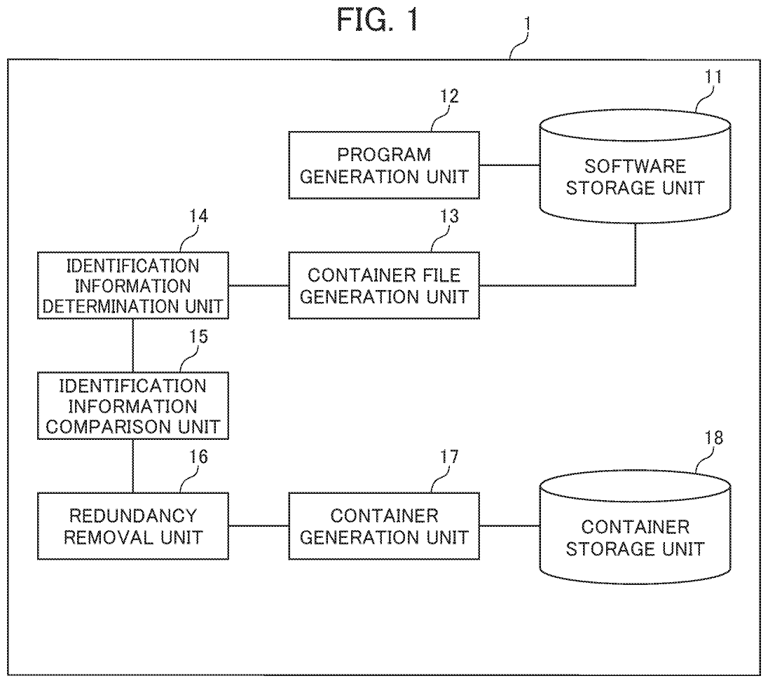

Hereinafter, an information processing device 1 and recording medium encoded with a program according to each embodiment of the present disclosure will be explained by referencing FIGS. 1 to 5. First, before explaining the information processing device 1 and program according to each embodiment, the container virtualization technology used in the information processing device 1 and program will be explained.

Container virtualization technology is technology which constructs a plurality of virtual environments on one physical device (for example, a physical server), by causing a plurality of containers in which a software module is virtualized to operate. With container virtualization technology, for example, resources of one physical device are divided, and a container operates in each of the divided resources. In particular, with container virtualization technology, it is possible to execute a plurality of containers in the process of a host OS of the physical device. The container, for example, is generated based on a container file generated by containerizing the software module. More specifically, the container is generated by instantiating a container image obtained by the visualization of a container file.

Herein, an example of generating an application using a plurality of containers with the container virtualization technology will be explained. As the application, for example, an application is created such that conducts the exchange (communication) of data between containers. In this case, the container on the other end conducting the exchange of data is identified using identification information from other containers.

However, an independently generated containers may be assigned identification information overlapping other containers. Therefore, the information processing device 1 and program according to each embodiment detect redundant identification information, and remove redundancy. It should be noted that, in each of the following embodiments, the identification information is explained with a container image name (for example, class) and a container name (for example, instance).

### First Embodiment

Next, the information processing device 1 and program according to a first embodiment of the present disclosure will be explained by referencing FIGS. 1 to 4. The information processing device 1 according to the present embodiment, for example, is a terminal for an application developer, or a combination of a network server (cloud server) and terminal for a developer. In the present embodiment, the information processing device 1 generates an application, using a plurality of containers in which a software module is virtualized. The information processing device 1, as shown in FIG. 1, includes: a software storage unit 11, program generation unit 12, container file generation unit 13, identification information determination unit 14, identification information comparison unit 15, redundancy removal unit 16, container generation unit 17, and container storage unit 18.

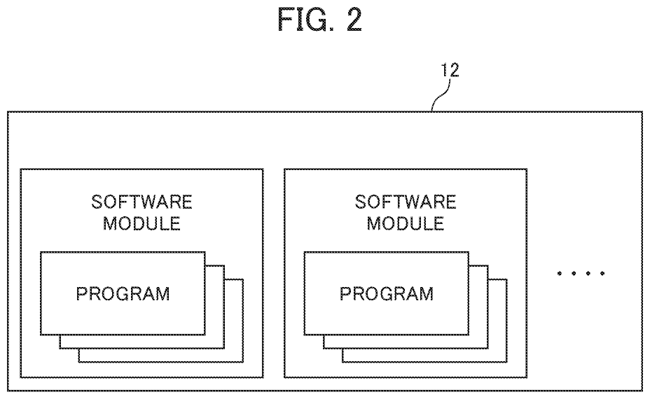

The software storage unit 11, for example, is a hard disk, or a secondary storage medium such as SSD. The software storage unit 11, as shown in FIG. 2, stores a plurality of software modules in which a plurality of programs is packaged.

The program generation unit 12, for example, is realized by a CPU operating. The program generation unit 12 generates a program constituting a software module. The program generation unit 12 generates a program based on the input to an input unit (not shown) such as a keyboard, for example. In addition, the program generation unit 12 is configured to make programs stored in the software storage unit 11 to be editable. The program generation unit 12 stores a generated or edited program in the software storage unit 11.

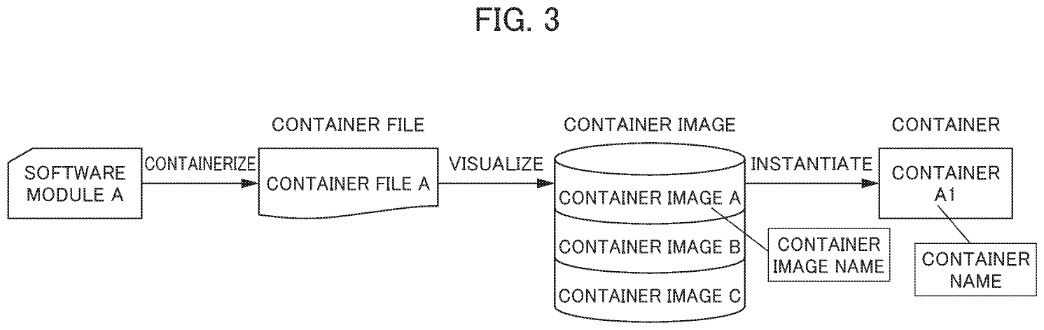

The container file generation unit 13 is realized by a CPU operating, for example. The container file generation unit 13 generates a container file from a software module. The container file generation unit 13, for example, generates a container file including commands, etc. upon visualization described later, from a software module. In the present embodiment, the container file generation unit 13, for example, generates a container file including a new container in which “new container added to application” or “already generated container” are corrected, by generating sequential container files from the software modules stored in the software storage unit 11. The container file generation unit 13, for example, generates a container file to which the name “A” is assigned, from a software module to which the name “A” is assigned, as shown in FIG. 3.

The identification information determination unit 14, for example, is realized by a CPU operating. The identification information determination unit 14 determines, as new identification information, the identification information that is new, assigned to a container image and container to be generated from a container file. The identification information determination unit 14 determines the name of a container image obtained from a container file of name “A” as “A” according to visualization described later, for example. In addition, the identification information determination unit 14 determines the name of a container obtained by instancing described later as “A1”, for example.

The identification information comparison unit 15, for example, is realized by a CPU operating. The identification information comparison unit 15 compares new identification information with existing identification information, which is identification information of another generated container image and container. The identification information comparison unit 15, for example, performs comparison while defining identification information determined relative to a container file which was determined immediately before as “new identification information”, and defining identification information of a container file determined relative to a container file before this, and in an operable state (state not deleted) as “existing identification information”.

The redundancy removal unit 16 is realized by a CPU operating, for example. The redundancy removal unit 16 removes redundancy of existing identification information and new identification information, based on the comparison result. The redundancy removal unit 16, for example, eliminates a container and container image identified by existing identification information including the same image name as an image name of a container image included in the new identification information. In addition, the redundancy removal unit 16, for example, renames the container name and container image name of either one of a container identified by new identification information and a container identified by existing identification information, for “container identified by existing identification information” including the same container name as a container name included in the new identification information. More specifically, the redundancy removal unit 16 renames the container name and container image name, for a container identified by existing identification information, including the same container name as a container name included in the new identification information. In addition, the redundancy removal unit 16, for example, overwrites the “container identified by existing identification information” including the same image name as the image name of a container image included in the new identification information.

The container generation unit 17, for example, is realized by a CPU operating. The container generation unit 17 generates a container from a container file. More specifically, the container generation unit 17 generates a container image which is identified by new identification information (container image name), by visualizing the container file. In addition, the container generation unit 17 generates a container which is identified by new identification information (container name), by instantiating the generated container image.

The container storage unit 18 is a secondary storage medium such as memory, for example. The container storage unit 18 stores the generated container.

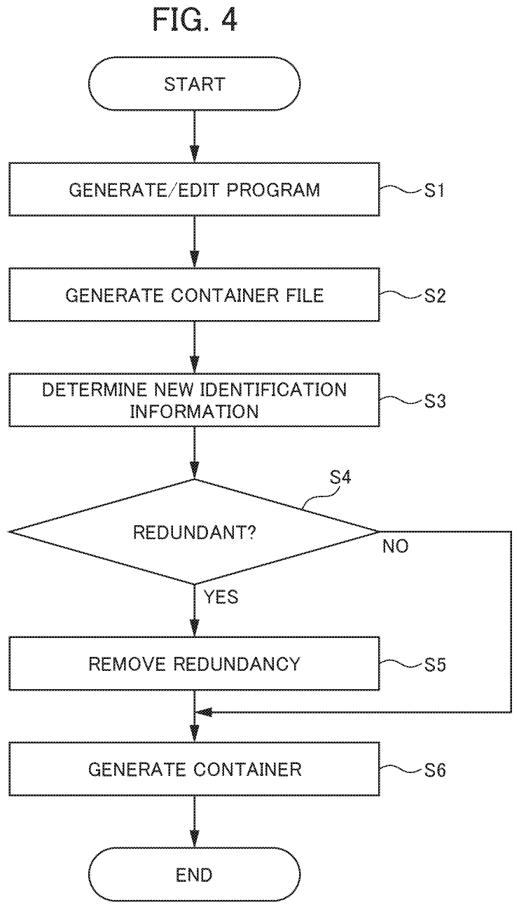

Next, the flow of processing of the information processing device 1 will be explained by referencing the flowchart of FIG. 4. First, a program stored in the software storage unit 11 is generated or edited by a program generated by the program generation unit 12 (Step S1). The software storage unit 11 stores the generated or edited program.

Next, the container file generation unit 13 generates a container file with an instruction of container generation as a trigger (Step S2). The container file generation unit 13, for example, reads out a software module stored in the software storage unit 11, and generates a container file. Next, the identification information determination unit 14 determines, as new identification information, the identification information which is new relative to the container image and container obtained from the generated container file (Step S3).

Next, the identification information comparison unit 15 compares the new identification information with existing identification information, which is identification information of another generated container image and container (Step S4). In the case of there being existing identification information which is the same as the new identification information (Step S4: YES), the processing advances to Step S5. On the other hand, in the case of there not being existing identification information which is the same as the new identification information (Step S4: NO), the processing advances to Step S6.

In Step S5, the redundancy removal unit 16 removes redundancy between the existing identification information and new identification information. For example, in the case of there being redundancy of container image names, with the redundancy removal unit 16, the deletion of a container identified by existing identification information, or overwriting by a container identified by new identification information is executed. In addition, for example, in the case of there being redundancy of the container name, the redundancy removal unit 16 changes the container name of the container identified by the new identification information. Then, the processing advances to Step S6.

In Step S6, the container generation unit 17 generates the container. The container generation unit 17 stores the generated container in the container storage unit 18. Processing by the main flow thereby ends.

Next, a program will be explained. Each configuration included in the information processing device 1 can be respectively realized by hardware, software or a combination of these. Herein, being realized by software indicates the matter of being realized by a computer reading and executing a program.

The program can be stored using various types of non-transitory computer readable media, and supplies to the computer. Non-transitory computer readable medium includes various types of tangible storage media. Examples of non-transitory computer readable media include magnetic recording media (e.g., flexible disk, magnetic tape, hard disk drive), magneto-optical recording media (e.g., magneto-optical disk), CD-ROM (Read Only Memory), CD-R, CD-R/W and semiconductor memory (e.g., mask ROM, PROM (programmable ROM), EPROM (Erasable PROM), flash ROM, RAM (random access memory)). In addition, the display program may be supplied to the computer by way of various types of transitory computer readable media. Examples of transitory computer readable media include electrical signals, optical signals and electromagnetic waves. Transitory computer readable media can supply programs to the computer via wired communication paths such as electric wires and optical fiber, or wireless communication paths.

According to the above information processing device 1 related to the first embodiment, the following effects are exerted.

(1) The information processing device 1 which generates an application using a plurality of containers virtualizing software modules includes: the container file generation unit 13 which generates a container file from a software module; the identification information determination unit 14 which determines identification information which is new relative to a container image and a container obtained from the generated container file as new identification information; an identification information comparison unit 15 which compares between the new identification information and existing identification information that is identification information of another generated container image and container; and the redundancy removal unit 16 which removes redundancy of the existing identification information and new identification information based on comparison results. It is thereby possible to easily remove redundancy of identification information of a newly generated container image and container, and identification information of an already generated container image and container. Therefore, it is possible to easily construct an execution environment of an application configured by a plurality of containers.
(2) The existing identification information includes an image name of a container image constituting a generated container, and a container name of a generated container, and the new identification information includes: an image name of a container image constituting a new container, and a container name of a new container. It is thereby possible to suppress image names and container names from overlapping, and easily construct an execution environment of an application.
(3) The redundancy removal unit 16 deletes a container and container image identified by existing identification information, including the same image name as the image name of a container image included in the new identification information. It is thereby possible to suppress execution of an application from being unintentionally inhibited.
(4) The redundancy removal unit 16 renames the container name and container image name for a container identified by the existing identification information, including a container name that is the same as the container name included in the new identification information. It is thereby possible to suppress execution of an application from being unintentionally inhibited.

### Second Embodiment

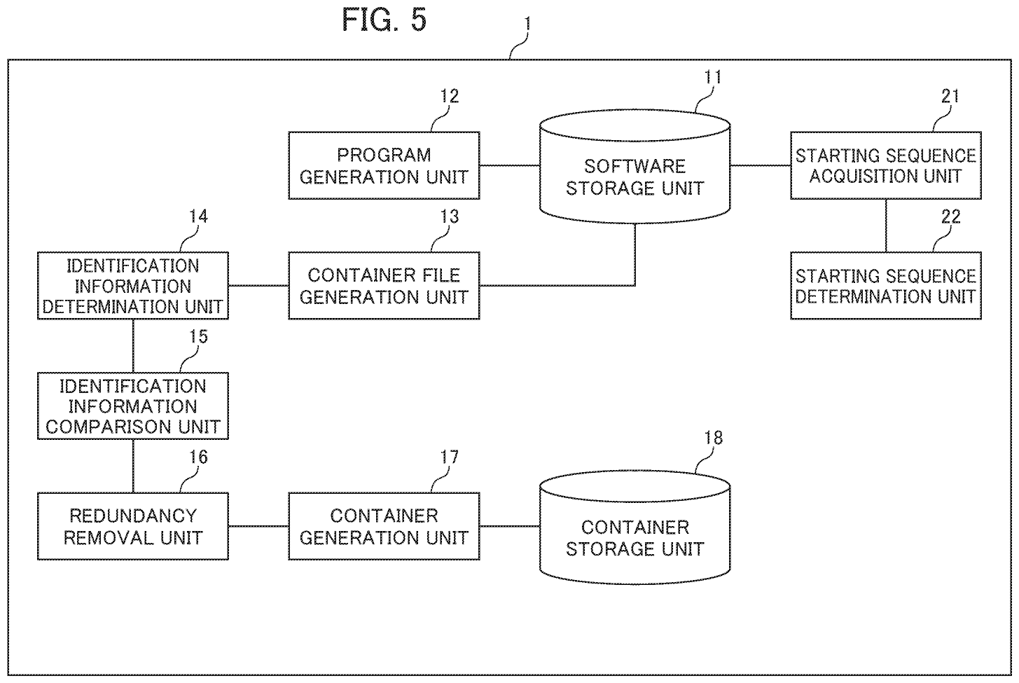

Next, the information processing device 1 and program according to a second embodiment of the present disclosure will be explained by referencing FIG. 5. In the explanation of the second embodiment, the same reference symbols are assigned to constituent elements which are the same as the aforementioned embodiment, and an explanation thereof is omitted or simplified. The information processing device 1 and program according to the second embodiment differ from the first embodiment in the point of further including a starting sequence acquisition unit 21 and starting sequence determination unit 22, as shown in FIG. 5.

The starting sequence acquisition unit 21, for example, is realized by a CPU operating. The starting sequence acquisition unit 21 acquires a starting sequence of a generated new container and a generated container, as “starting sequence information”. In the present embodiment, the starting sequence acquisition unit 21 acquires starting sequence information stored in the software storage unit 11. The starting sequence acquisition unit 21, for example, acquires starting sequence information indicating the starting sequence of containers, such that executes the start of containers defining variables in the containers of a database, after the start of containers constructing the database.

The starting sequence determination unit 22, for example, is realized by a CPU operating. The starting sequence determination unit 22 determines the starting sequence of containers based on the starting sequence information. The starting sequence determination unit 22 sends a table of a determined starting sequence of containers to the application start unit (not shown) before the start of the application.

According to the information processing device 1 and program related to the second embodiment, the following effects are exerted.

(5) The information processing device 1 further includes the starting sequence acquisition unit that acquires the starting sequence of a generated new container and already generated containers as starting sequence information; and the starting sequence determination unit 21 that determines the starting sequence of containers before execution of an application, based on the acquired starting sequence information. It is thereby possible to determine the starting sequence of containers before start of the application. Therefore, the starting of the application can be further optimized.

Although each preferred embodiment of an information processing device and program of the present disclosure has been explained above, the present disclosure is not to be limited to the aforementioned embodiments, and modifications thereto are possible where appropriate. For example, in the above-mentioned embodiments, a mode of adding a new or modified container to already generated containers has been explained; however, it is not to be limited thereto. For example, in order to newly execute an application, it may be a mode such that generates container files sequentially from software modules stored in the software storage unit 11.

In addition, in the above-mentioned embodiments, the determination and comparison of new identification information are executed after the generation of container files; however, it is not limited thereto. For example, the determination and comparison of new identification information may be executed before the generation of container files.

It should be noted that, in the above-mentioned embodiments, new identification information and existing identification information are compared for software modules sequentially read from the software module determination unit; however, it is not limited thereto. The identification information comparison unit 15 may be configured so as to compare the identification information of containers stored in the container storage unit 18 as existing identification information with the new identification information.

In addition, in the above-mentioned second embodiment, the information processing device may further include a starting sequence information generation unit (not shown) which generates starting sequence information, for at least one software module stored in the software storage unit 11. The starting sequence generation unit, for example, may generate starting sequence information with a sequence displayed on a display unit (not shown) such as a display as a starting sequence, by selecting software modules in order. In addition, the starting sequence generation unit may assign a number indicating the starting sequence to software modules, and generate starting sequence information defining the assigned number as the starting sequence.

### EXPLANATION OF REFERENCE NUMERALS

1 information processing device
13 container file generation unit
14 identification information determination unit
15 identification information comparison unit
16 redundancy removal unit
21 starting sequence acquisition unit
22 starting sequence determination unit

What is claimed is:

1. An information processing device for generating an application using a plurality of containers in which a software module is virtualized, the information processing device comprising:
a container file generation unit which generates a container file from the software module;
an identification information determination unit which determines identification information that is new, assigned to a container image and container to be generated from the container file, as new identification information;
an identification information comparison unit which compares the new identification information with existing identification information that is identification information of another container image and container which have been generated; and
a redundancy removal unit which removes redundancy of the existing identification information and the new identification information based on comparison results.

2. The information processing device according to claim 1,
wherein the existing identification information includes:
an image name of a container image constituting a generated container; and
a container name of the generated container, and
wherein the new identification information includes:
an image name of a container image constituting a new container; and
a container name of the new container.

3. The information processing device according to claim 2, wherein the redundancy removal unit deletes a container and a container image identified by the existing identification information, including an image name which is identical to the image name of a container image included in the new identification information.

4. The information processing device according to claim 2, wherein the redundancy removal unit renames a container name and a container image name for a container identified by the existing identification information including a container name which is identical to the container name included in the new identification information.

5. The information processing device according to claim 1, further comprising:
a starting sequence acquisition unit which acquires a starting sequence of a new container generated and a generated container as starting sequence information; and
a starting sequence determination unit which determines a starting sequence of containers, before execution of the application based on starting sequence information that was acquired.

6. A recording medium encoded with a program for causing a computer to operate as an information processing device which generates an application expressed by a container in which a software module is virtualized, the program causing the computer to function as:
a container file generation unit which generates a container file from the software module;
an identification information determination unit which determines identification information that is new relative to a container image and a container obtained from the container file generated, as new identification information;
an identification information comparison unit which compares the new identification information with existing identification information that is identification information of another container image and container which have been generated; and
a redundancy removal unit which removes redundancy of the existing identification information and the new identification information based on comparison results.
